(19) United States
(12) Patent Application Publication
(10) Pub. No.: US 2026/0261227 A1
(43) Pub. Date: Sep. 3, 2026

(54) SOLAR TRACKER WITH BIMETALLIC PASSIVE ROTATIONAL DRIVE

(71) Applicant: Nextpower LLC, Fremont, CA (US)

(72) Inventors: Nathan Malone, Fremont, CA (US); Alexander W. Au, Oakland, CA (US)

(21) Appl. No.: 19/539,876

(22) Filed: Feb. 13, 2026

Related U.S. Application Data
(60) Provisional application No. 63/764,688, filed on Feb. 28, 2025.

(51) Int. Cl. H02S 20/10; F24S 25/12; F24S 30/425; H02S 20/32; H02S 40/34

(52) U.S. Cl. CPC H02S 20/10; F24S 25/12; F24S 30/425; H02S 20/32; H02S 40/34

(57) ABSTRACT

A solar tracker includes a ground pier including a first leg and a second leg, each of the first leg and the second leg configured to be partially embedded in a ground surface, and a solar module supported by the ground pier. At least one of the first leg or the second leg comprises a bimetallic strip.

### RELATED APPLICATIONS

This application claims the benefit of U.S. Provisional Patent Application No. 63/764,688, filed Feb. 28, 2025, the entire contents of which are incorporated herein by reference.

### TECHNICAL FIELD

This disclosure relates generally to solar power generation systems, and more particularly, to solar tracker systems using bimetallic metals as a passive rotational drive mechanism.

### BACKGROUND

Solar panels are generally composed of an array of solar cells, which are interconnected to each other. The cells are often arranged in series and/or parallel groups of cells in series. Solar cells and solar panels are typically more efficient in sunny conditions when oriented towards the sun at a certain angle (e.g., angled to present a solar panel surface area that is normal or perpendicular to the direction of incident rays of sunlight, a “normal incidence angle”). Many solar panel systems are designed in combination with solar trackers, which enable the solar panels or solar modules to follow the sun's trajectory across the sky from east to west throughout a typical day in an attempt to maximize the electrical generation capabilities of the solar panel systems.

Typically, a relatively large number of solar cells are arranged in an array to generate energy in sufficient amounts to be usable, for example as part of an energy grid. As a result, solar trackers have been developed that are quite large, spanning hundreds of feet in length and including hundreds of individual solar modules that are mechanically coupled to support structures. An array of solar trackers may be formed of a plurality of solar tracker rows that are oriented generally parallel to each other, often in a north-to-south configuration, which may facilitate rotating or tilting the solar modules throughout the day to attempt to follow the trajectory of the sun and maximize the energy produced.

Often, solar trackers may be reliant upon a mechanical actuator. However, some solar trackers may be reliant upon passive materials, such as thermally active components, e.g., liquid freon or other volatile liquids, that may condense when exposed to sunlight, thereby shifting a center of gravity. A potential issue with these types of solar trackers can be that the benefits of the solar trackers may be outweighed by their cost. The present disclosure seeks to address the shortcomings of prior tracker systems.

### SUMMARY

In general, the present disclosure relates to support structures for solar arrays within a solar tracking system. In one example, a solar tracker may include a ground pier including a first leg and a second leg, each of the first leg and the second leg may be configured to be partially embedded in a ground surface, and a solar module supported by the ground pier. At least one of the first leg or the second leg may comprise a bimetallic strip.

Additionally or alternatively, both the first leg and the second leg of the ground pier may comprise bimetallic strips.

Additionally or alternatively, the bimetallic strip may be shaped in one of the group consisting of: a disc, a ribbon, a coil, a helix, or a spiral.

Additionally or alternatively, the bimetallic strip may comprise a first metal on first side and a second metal on a second side, opposite the first side.

Additionally or alternatively, the first metal may be a first one of the group consisting of: copper, steel, brass, aluminum, iron, nickel, or an alloy combination thereof, and the second metal may be a second one of the group consisting of: copper, steel, brass, aluminum, iron, nickel, or an alloy combination thereof, and the second one of the group may be different than the first one of the group.

Additionally or alternatively, the first metal may have a first coefficient of thermal expansion, and the second metal may have a second coefficient of thermal expansion different than the first coefficient of thermal expansion.

Additionally or alternatively, the first metal may have a higher thermal expansion coefficient than the second metal.

Additionally or alternatively, the first side may be an inside of the first leg and the second side may be an outside of the first leg, the first side configured to expand when heated above an ambient temperature.

Additionally or alternatively, the first side may be an inside of the second leg and the second side may be an outside of the second leg, the first side configured to expand when heated above an ambient temperature.

Additionally or alternatively, the solar module may be directly coupled to the ground pier.

Additionally or alternatively, a torque tube may be supported by the ground pier, the torque tube configured to couple to the solar module to support the solar module upon the ground pier.

Additionally or alternatively, the solar module may be sized to shade the first leg and the second leg of the ground pier when a thermal energy source is directly above the solar tracker.

In another example, a solar tracker may include a ground pier including a first leg and a second leg, the first leg including a first inner side and a second outer side, the second leg including a second inner side and a second outer side, the first inner side generally facing the second inner side, the first leg and the second leg comprising a first bimetallic strip and a second bimetallic strip respectively, and a solar module supported by the ground pier.

Additionally or alternatively, the first bimetallic strip may comprise a first material on a first inner side of the first leg and a second material on a first outer side of the first leg, and the second leg may comprise a third material on a second inner side and a fourth material on a second outer side. The first inner side of the first leg generally faces the second inner side of the second leg.

Additionally or alternatively, the first material may have a higher coefficient of thermal expansion than the second material, and the fourth material may have a higher coefficient of thermal expansion than the third material.

Additionally or alternatively, the first material and the third material may comprise the same material, and the second material and the fourth material may comprise the same material.

Additionally or alternatively, the solar tracker may be configured to rotate in a first direction toward a thermal energy source via heating of the first leg, and the solar tracker may be configured to rotate in a second direction toward the thermal energy source via heating of the second leg.

Additionally or alternatively, the solar module may be sized to shade the first leg and the second leg of the ground pier when a thermal energy source is directly above the solar tracker.

In another example, a method of rotating a solar tracker may include providing a solar module supported by a ground pier, the ground pier including a first leg comprising a first bimetallic strip and a second leg comprising a second bimetallic strip, receiving thermal energy at the first leg from a thermal energy source, the thermal energy causing the first bimetallic strip to bend from an unbent position, the bending of the first bimetallic strip causing the solar tracker to rotate in a first direction toward the thermal energy source, and receiving thermal energy at the second leg from the thermal energy source, the thermal energy causing the second bimetallic strip to bend from an unbend position, the bending of the second bimetallic strip causing the solar tracker to rotate in a second direction, opposite the first, toward the thermal energy source.

Additionally or alternatively, the method may further include stop receiving thermal energy at the first leg from the thermal energy source, the first bimetallic strip configured to return to the unbent position after not receiving thermal energy for a first period of time, and stop receiving thermal energy at the second leg from the thermal energy source, the second bimetallic strip configured to return to the unbent position after not receiving thermal energy for a second period of time.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is an elevation view of a solar tracker provided in accordance with the present disclosure;

FIG. 2 is a schematic, top view of a solar tracking system;

FIG. 3 is a front view of the solar tracker pier, in accordance with the disclosure;

FIG. 4 illustrates the shape changes of a bimetallic metal in response to being heated or cooled; and

FIGS. 5A to 5E illustrate the solar tracker pier, as in FIG. 3, bending to follow the sun's trajectory.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

Embodiments disclosed herein include various devices, systems, and methods relating to solar tracker foundations. Certain embodiments disclosed herein relate to solar tracker supports configured to facilitate improved structural stability for solar tracking systems. Certain embodiments disclosed herein can improve solar tracking system structural stability while increasing the efficiency of solar tracking foundation installation and reducing costs (e.g., foundation and/or support material costs) associated with solar tracker foundations and supports.

Often, solar trackers may be reliant upon a mechanical actuators/drives. However, some solar trackers may be reliant upon passive materials and/or passive drives. Passive drives may be most efficient or optimal for certain environments or locations, such as, for example, deserts, mountainous regions, a lunar surface, or any other location that may be exposed to high altitudes, high levels of dust/debris, and/or is generally hard to difficult to access. Passive drives may provide an advantage over mechanical drives as they may include less failure points, such as, for example, motors, gears, electronic controls, wireless communications, or the like. Further, solar trackers with passive drives may weigh less than solar trackers with mechanical drives. Described herein is an exemplary solar tracker including a passive drive, which may provide certain benefits over solar trackers having mechanical drives.

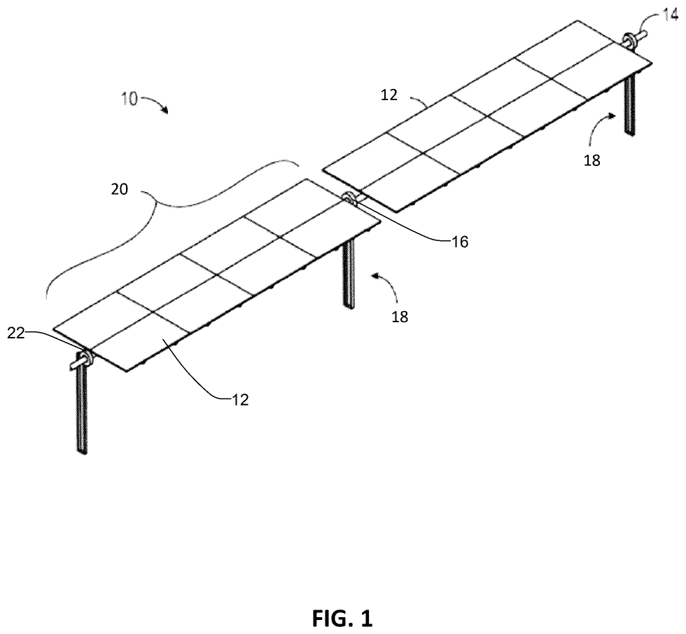

FIG. 1 is an elevation view of a common arrangement of a solar tracker 10 provided in accordance with the present disclosure. In some applications, a plurality of solar trackers 10 may be arranged in a north-south longitudinal orientation to form rows of a solar array. The solar tracker 10 may be formed of a plurality of bays 20 defined by the distance between ground pier support structures 18 (generally referenced herein as piers 18). The ground pier 18 may be disposed in spaced relation to one another and partially embedded in the earth. In some examples, the ground piers 18 may be multi-component tubular support members, or A-frame supports, and/or may be configured to couple to A-frame supports. The piers 18 may have one or more embedment in the ground, such as one for each leg of an A-frame support where the embedments are spaced apart in the east-west direction. FIG. 1 illustrates two bays 20 of the solar tracker 10. However, it will be appreciated that the solar tracker 10 may include four bays, six bays, ten bays, twenty bays, or any other suitable number of bays as desired. At each pier 18 is either a bearing 22 or generally near the center of the solar tracker 10 a drive mechanism 16. Each of the bearings 22 and the drive mechanism 16 are supported by one of the piers 18. Activation of the drive mechanism rotates a torque tube 14 about an axis of rotation and thus rotates one or more solar modules 12 mounted to the torque tube 14 such that the solar modules 12 can be oriented to a desired position. That desired position may be to a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

The torque tube 14 is sized (e.g., diameter, wall thickness, material) such that sag between the piers 18 is reduced and to absorb torsional loads applied to the torque tube 14 by wind loading. In addition, since there is often just a single drive mechanism 16, the specifications for the torque tube 14 may desire to eliminate twist of the torque tube 14 along its length. Any twist would result in the solar modules 12 being oriented differently from what is desired, and thus again reduce the output and efficiency of the solar tracker 10, particularly, as the solar tracker 10 is rotated to the extreme angles of permitted range (e.g., +/−75 degrees or more), for example, during stowing.

As will be appreciated, the solar modules 12 must be supported on the torque tube 14. This is typically achieved by a bracket system (not shown in FIG. 1) that is attached to the torque tube 14 substantially perpendicular to the longitudinal axis of the torque tube 14. The torque tube 14 may be rotatable about its longitudinal axis to adjust an angular orientation of the solar modules 12 relative to the sun, while supporting the solar modules 12 on the bracket system. The bracket system may take many forms including two pieces of shaped steel, which may be arranged to sandwich the solar modules 12, and may be configured to connect to a rail, which is then coupled to the torque tube 14.

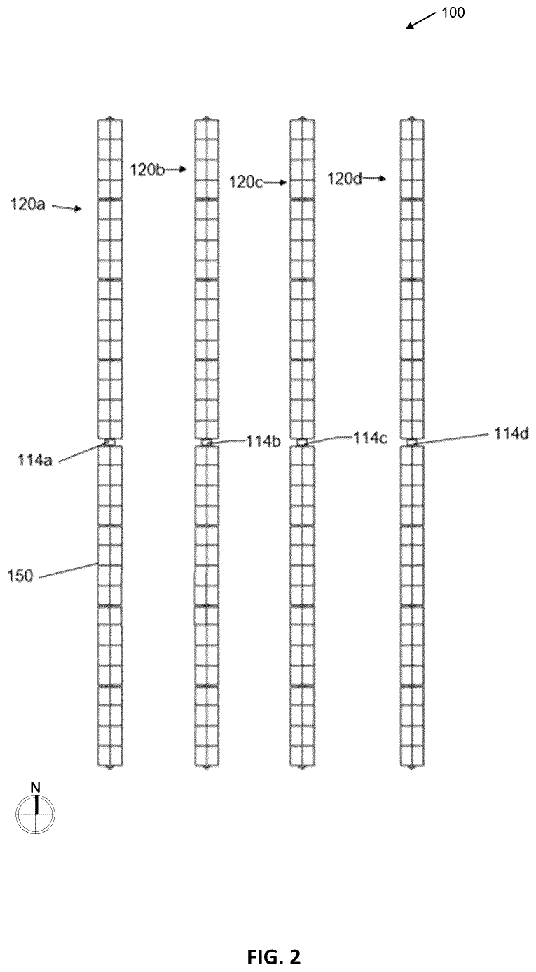

FIG. 2 is a top view of a solar tracker system 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44°range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other solar tracker rows 120, and exterior solar tracker rows are solar tracker rows 120 with one other solar tracker row 120 on one side of the exterior solar tracker row and no solar tracker row 120 positioned on the other side, opposite the one side of the exterior solar tracker row. The solar tracker rows 120 may be composed of a plurality of solar module assemblies 150 arranged in a north-south longitudinal orientation to form the solar tracker rows 120. The solar module assemblies 150 may include a plurality of solar modules, such as the solar modules 12, as in FIG. 1. Each one of the plurality of solar module assemblies 150 may be supported on a torque tube 114a, 114b, 114c, 114d (generally referred to herein as torque tube 114), which in turn is supported by a plurality of support piers (not explicitly shown in FIG. 2). The torque tube 114 may be an example of the torque tube 14, as in FIG. 1. As shown, the solar tracker rows 120 may be separated by a space sufficient to allow machinery to travel therethrough to allow for cleaning and maintenance.

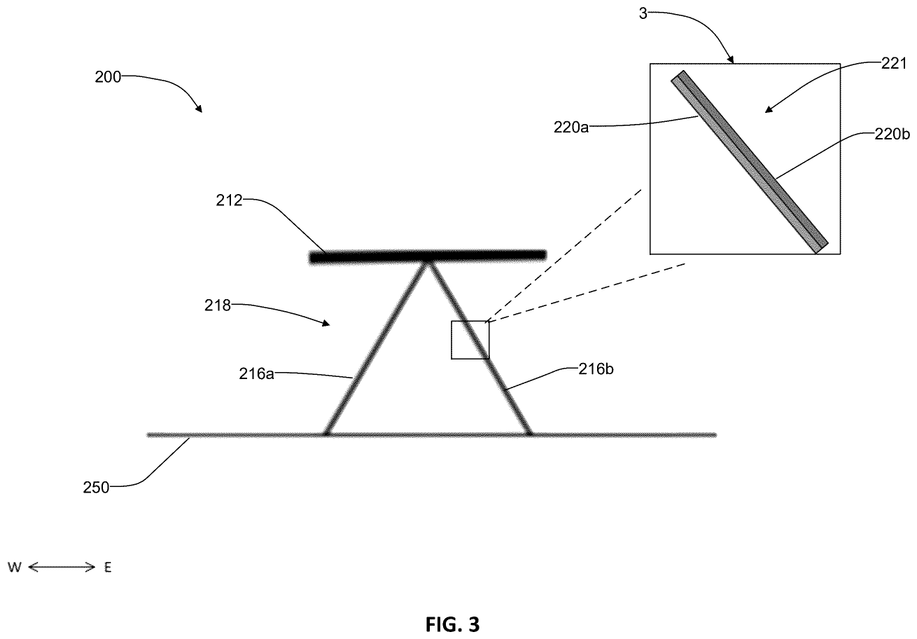

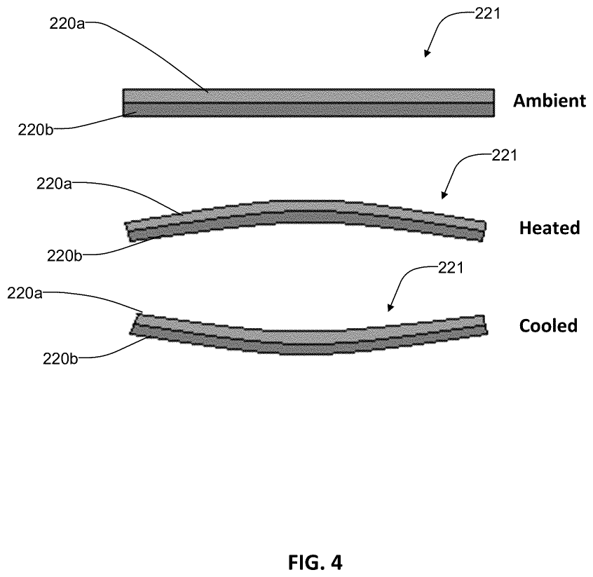

FIG. 3 is a front view of a solar tracker 200, and FIG. 4 illustrates the shape changes of a bimetallic strip 221 in response to being heated or cooled. The solar tracker 200 may be an example of the solar tracker 10, as in FIG. 1. The solar tracker 200 may be formed of a solar module 212 supported by a ground pier 218. The ground pier 218 may be partially embedded in a ground surface. In some examples, the ground surface 250 may be soil, caliche, rocks, clay, sand, and in some cases, lunar surfaces. In some examples, the ground pier 218 may be a multi-component tubular support member, or an A-frame support, and/or may be configured to couple to A-frame supports. As shown in FIG. 3, the ground pier 218 may have one or more embedments in the ground, such as a first leg 216a and a second leg 216b spaced apart in the east-west direction.

In some examples, the first leg 216a and the second leg 216b may each be formed from the bimetallic metal strip 221. The bimetallic strip 221 may be formed from a first strip 220a formed from a first metal and a second strip 220b formed from a second metal, as shown in Square 3. The first strip 220a and the second strip 220b may be coupled together along their length via riveting, brazing, welding, or any other suitable coupling mechanism, to form the bimetallic strip 221. The bimetallic strip 221 may be formed as a disc, a ribbon, a coil, a helix, a spiral, or any other suitable formation. In some examples, the first strip 220a and/or the second strip 220b may be formed from copper, steel, brass, aluminum, iron, nickel, zinc, titanium, chromium, or any other suitable metal and/or alloy as desired.

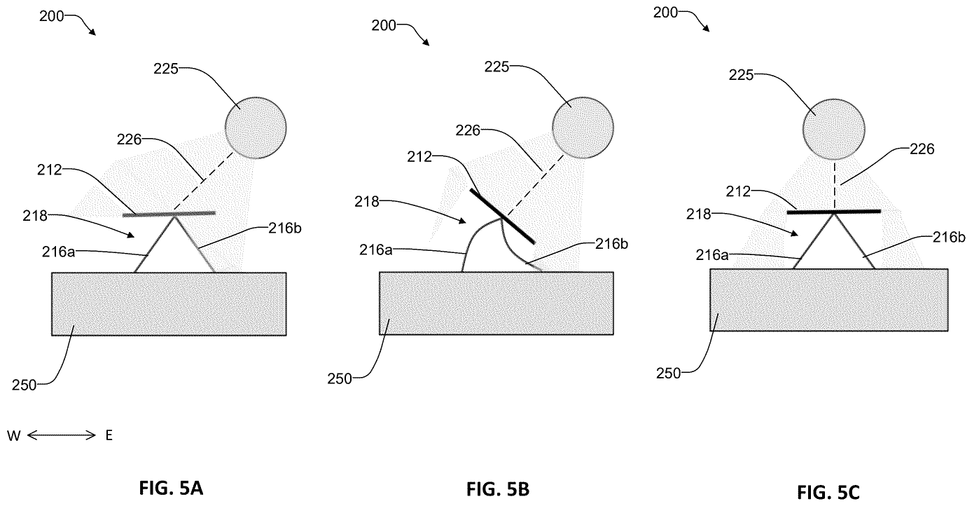

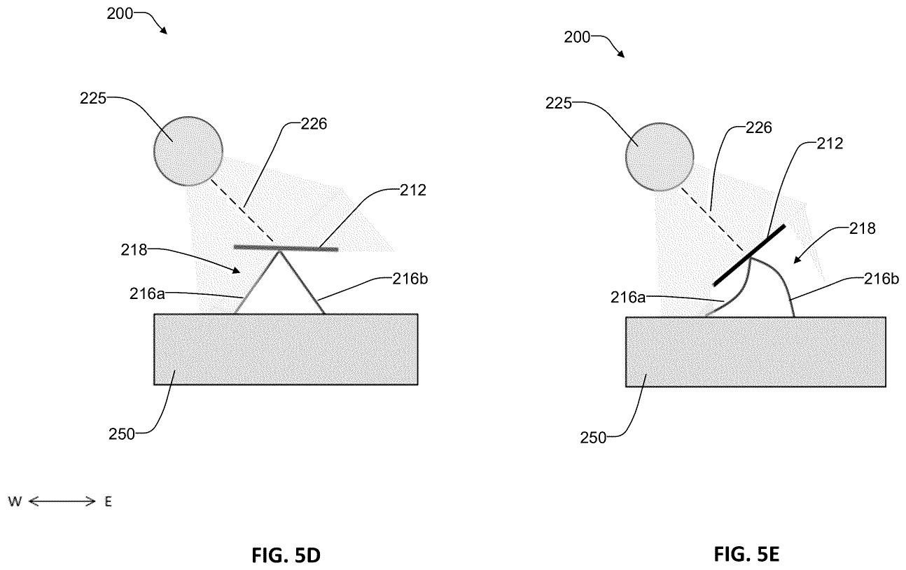

The first metal and the second metal may differ such that each metal may include differing heating properties. In such examples, the combination of the metals may be used to convert a temperature change into mechanical displacement. For example, the first metal forming the first strip 220a may include a higher coefficient of thermal expansion than the second metal of the second strip 220b. The different coefficients of thermal expansion force a generally flat bimetallic strip to bend one way if heated, and in the opposite direction if cooled below its initial temperature, as shown in FIG. 4. In other words, this causes the strip to bend in one direction when heated and in the opposite direction when cooled. The metal having a lower thermal expansion coefficient is sometimes called the passive metal, while the other metal having the higher thermal expansion is called the active metal. The metal with the higher coefficient of thermal expansion will be on the outside of the curve when the strip is heated. In the example shown, the first metal of the first strip 220a may be formed from brass, which includes a higher coefficient of thermal expansion than the second metal, which may be steel. The first metal of the first strip 220a may be positioned on the inside of the second leg 216b, which may result in the first metal of the first strip 220a being positioned on the “outside of the curve” as the second leg 216b curves (e.g., bends) when heated, as shown in FIGS. 5A to 5E. The choice of metals may change how much the bimetallic strip 221 bends, and the temperature required to produce such a bend. Material selection has a significant impact on the working temperature range of the bimetallic strip 221, with some having a temperature limit up to 500° C., with others only reaching 150° C. before failing. While the second leg 216 b is discussed with reference to FIGS. 3 and 4, it will be appreciated that the description further applies to the first leg 216a.

It will be appreciated that while typical solar modules are supported on a torque tube, the solar module 212 may be directly coupled to the ground pier 218. However, this is not always the case, and in some examples, the solar module 212 may be coupled to a torque tube. This is typically achieved by a bracket system (not shown in FIG. 3) that is attached to the torque tube 214 substantially perpendicular to the longitudinal axis of the torque tube 214. The torque tube 214 may be rotatable about its longitudinal axis to adjust an angular orientation of the solar module 212 relative to the sun, while supporting the solar module 212 on the bracket system.

FIGS. 5A to 5E illustrate the solar tracker pier 218 bending to follow a sun's 225 trajectory 226 as the sun 225 moves from an eastward direction to a westward direction. As shown in FIGS. 5A to 5E, the solar tracker pier 218 may be embedded into the ground surface 250. FIG. 5A shows the solar tracker 200 with the solar module 212 in a neutral (e.g., 0-degree angle) position. The sun 225 is in an eastern position and therefore the sun's 225 rays are reaching the second leg 216b of the pier 218. As the sun's 225 rays heat up the bimetallic metal (e.g., bimetallic strip 221) of the second leg 216b, the second leg 216b will begin to bend such that the solar module 212 faces the sun 225 directly, as shown in FIG. 5B. As the sun's 225 trajectory 226 changes, the bimetallic metal of the second leg 216b may begin to cool down, and return to ambient temperature, thereby returning to an unbent position, as shown in FIG. 5C. As shown in FIG. 5C, the solar tracker 200 with the solar module 212 has moved to a neutral (e.g., 0-degree angle) position, as the sun 225 is directly above the solar tracker 200. In the example shown in FIG. 5C, the first leg 216a and the second leg 216b are in the shadow of the solar module 212 and therefore each of the first leg 216a and the second leg 216b may remain at an ambient temperature, in which the first leg 216a and the second leg 216b may remain in an unbending position.

Similarly, FIG. 5D shows the solar tracker 200 with the solar module 212 in a neutral (e.g., 0-degree angle) position. The sun 225 is in a western position and therefore the sun's 225 rays are reaching the first leg 216a of the pier 218. As the sun's 225 rays heat up the bimetallic metal (e.g., bimetallic strip 221) of the first leg 216a, the first leg 216a will begin to bend such that the solar module 212 faces the sun 225 directly, as shown in FIG. 5E. As the sun's 225 trajectory 226 changes, the bimetallic metal of the second leg 216a may begin to cool down, and return to ambient temperature, thereby returning to an unbent position, as shown in FIG. 5C.

As previously stated, passive drives may be most efficient or optimal for certain environments or locations, such as, for example, deserts, mountainous regions, lunar surfaces, or any other location that may be exposed to high altitudes, high levels of dust/debris, or are generally hard to difficult to access. Passive drives may be optimal for space or lunar locations and/or other remote locations where repairs may be difficult. Passive drives may provide an advantage over mechanical drives as they may include less failure points, such as, for example, motors, gears, electronic controls, wireless communications, or the like. Further, solar trackers with passive drives may weigh less than solar trackers with mechanical drives. In some examples, lunar applications for solar tracking may be beneficial due to lack of diffused irradiance, lack of gravity, lack of wind, and the like, on lunar surfaces. The use of a passive drive may allow the solar tracker to use the sun's energy (e.g., heat) to bend the solar modules in the direction of the sun, thereby attaining optimal energy harvest.

Various non-limiting exemplary embodiments have been described. It will be appreciated that suitable alternatives are possible without departing from the scope of the examples described herein.

1. A solar tracker comprising:
a ground pier including a first leg and a second leg, each of the first leg and the second leg configured to be partially embedded in a ground surface; and
a solar module supported by the ground pier;
wherein at least one of the first leg or the second leg comprise a bimetallic strip.

2. The solar tracker of claim 1, wherein both the first leg and the second leg of the ground pier comprise bimetallic strips.

3. The solar tracker of claim 1, wherein the bimetallic strip is shaped in one of the group consisting of: a disc, a ribbon, a coil, a helix, or a spiral.

4. The solar tracker of claim 1, wherein the bimetallic strip comprises a first metal on first side and a second metal on a second side, opposite the first side.

5. The solar tracker of claim 4, wherein the first metal is a first one of the group consisting of: copper, steel, brass, aluminum, iron, nickel, or an alloy combination thereof;
wherein the second metal is a second one of the group consisting of: copper, steel, brass, aluminum, iron, nickel, or an alloy combination thereof; and
wherein the second one of the group is different than the first one of the group.

6. The solar tracker of claim 4, wherein the first metal has a first coefficient of thermal expansion; and
the second metal has a second coefficient of thermal expansion different than the first coefficient of thermal expansion.

7. The solar tracker of claim 6, wherein the first metal has a higher thermal expansion coefficient than the second metal.

8. The solar tracker of claim 7, wherein the first side is an inside of the first leg and the second side is an outside of the first leg, the first side configured to expand when heated above an ambient temperature.

9. The solar tracker of claim 7, wherein the first side is an inside of the second leg and the second side is an outside of the second leg, the first side configured to expand when heated above an ambient temperature.

10. The solar tracker of claim 1, wherein the solar module is directly coupled to the ground pier.

11. The solar tracker of claim 1, further comprising a torque tube supported by the ground pier, the torque tube configured to couple to the solar module to support the solar module upon the ground pier.

12. The solar tracker of claim 1, wherein the solar module is sized to shade the first leg and the second leg of the ground pier when a thermal energy source is directly above the solar tracker.

13. A solar tracker comprising:
a ground pier including a first leg and a second leg, the first leg including a first inner side and a second outer side, the second leg including a second inner side and a second outer side, the first inner side generally facing the second inner side, the first leg and the second leg comprising a first bimetallic strip and a second bimetallic strip respectively; and
a solar module supported by the ground pier.

14. The solar tracker of claim 13, wherein the first bimetallic strip comprises a first material on a first inner side of the first leg and a second material on a first outer side of the first leg;
wherein the second leg comprises a third material on a second inner side and a fourth material on a second outer side; and
wherein the first inner side of the first leg generally faces the second inner side of the second leg.

15. The solar tracker of claim 14, wherein the first material has a higher coefficient of thermal expansion than the second material; and
wherein the fourth material has a higher coefficient of thermal expansion than the third material.

16. The solar tracker of claim 14, wherein the first material and the third material comprise the same material; and
wherein the second material and the fourth material comprise the same material.

17. The solar tracker of claim 13, wherein the solar tracker is configured to rotate in a first direction toward a thermal energy source via heating of the first leg; and
wherein the solar tracker is configured to rotate in a second direction toward the thermal energy source via heating of the second leg.

18. The solar tracker of claim 13, wherein the solar module is sized to shade the first leg and the second leg of the ground pier when a thermal energy source is directly above the solar tracker.

19. A method of rotating a solar tracker, comprising:
providing a solar module supported by a ground pier, the ground pier including a first leg comprising a first bimetallic strip and a second leg comprising a second bimetallic strip;
receiving thermal energy at the first leg from a thermal energy source, the thermal energy causing the first bimetallic strip to bend from an unbent position, the bending of the first bimetallic strip causing the solar tracker to rotate in a first direction toward the thermal energy source; and
receiving thermal energy at the second leg from the thermal energy source, the thermal energy causing the second bimetallic strip to bend from an unbend position, the bending of the second bimetallic strip causing the solar tracker to rotate in a second direction, opposite the first, toward the thermal energy source.

20. The method of claim 19, further comprising:
stop receiving thermal energy at the first leg from the thermal energy source, the first bimetallic strip configured to return to the unbent position after not receiving thermal energy for a first period of time; and
stop receiving thermal energy at the second leg from the thermal energy source, the second bimetallic strip configured to return to the unbent position after not receiving thermal energy for a second period of time.
